(19) United States
(12) Patent Application Publication
(10) Pub. No.: US 2021/0209715 A1
(43) Pub. Date: Jul. 8, 2021

(54) Real Time Betting and Fan Engagement System and Methods

(71) Applicant: Tomash Devenishek, Brentwodd, CA (US)

(72) Inventor: Tomash Devenishek, Brentwodd, CA (US)

(21) Appl. No.: 17/140,123

(22) Filed: Jan. 3, 2021

Related U.S. Application Data
(63) Continuation of application No. 62/957,149, filed on Jan. 4, 2020.

(51) Int. Cl. G06Q 50/34; G06Q 50/00; G07F 17/32

(52) U.S. Cl. CPC G06Q 50/34; G07F 17/3288; G07F 17/3244; G06Q 50/01

(57) ABSTRACT

A system and method for implementing a real time betting and social interactivity environment as a web or mobile companion experience supporting a live entertainment event. The system solves an inherent problem of present day betting systems are underpinned by bet structures that have a significant delay between the time between a bet opportunity is made available and the occurrences influencing the outcome of the bet taking place is due. The methods as described, leverage a scaled broadcast architecture and social interactivity layer approach with a result analogous to a digital version of a radio station broadcasting a signal to an infinite number of active listeners who are subscribed in real time to a digital channel in which they receive real time interactivity and social information. Such a channel subscription is then used to broadcast to users real time betting enquiries on as they happen moments within the event resulting in high concurrency and immediacy of the betting offering that can support short-lived, ephemeral betting propositions. The system, underpinned by the method, enables users to remain connected to its server system throughout the entertainment event. The social interactivity layer offers a variety of features enhancing the overall experience while keeping the user connected and actively subscribed to new betting opportunities. The method and system together combine to support a previously impossible real time, continuous, ephemeral betting experience that can be delivered to a large number of concurrent users making bets and interacting with one another in real time using one or more digital clients.

This application is a continuation of a U.S. Provisional Application No 62/957,149 entitled “Fan Engagement System And Methods”, filed Jan. 4, 2020.

### FIELD

The disclosure relates to the field of interactive betting, gamification and voting systems that can be used for engagement or gambling purposes.

With the proliferation of mobile devices and rich digital experiences, the entertainment and sports industries are seeing trends whereby fans are not satisfied with idly consuming a live entertainment event (such as being at a sporting arena during a match or watching a television program broadcast). Fans require supplementary activities to amplify and maximize their entertainment value and interest in the event. The system and methods improve the experience of fans through the means of combining gamification betting and social interactivity functions as critical improvements necessary to power the next generation of second screen fan experiences.

### BACKGROUND

When physically attending or watching a live entertainment event on a screen, fans are looking to be able predict what happens at any live point of the event via interactive means such as live betting or voting on the potential outcome of a portion of the event.

Current systems leverage user experience practices that rely upon request-response communication methods between user client and system server in which a client sends a request to the server to get a list of available betting or voting opportunities and then displays the response to the user. Such systems prove themselves as temporary destinations for a fan looking for a betting opportunity and are inefficient in delivering short lived, real time betting opportunities in a short span of time based on an ephemeral betting window such as a penalty kick being called during a soccer game. In order for users to become aware of a betting opportunity current systems require a fan to visit the system refresh information in a client via a check-in with a server system containing an updated availability of available bet and odd options, updating the client with server response and only then allow a user to render a bet response (e.g. I'd lie to bet $10 on outcome A of a new activity in an event). The structure of present bet types furthermore underlines the shortcomings of the current systems whereby the delay between the presentation of the betting opportunity and the activity that decides its outcome are usually measured in minutes, hours or days. Present systems fail to handle high concurrency loads and real time betting opportunities where the opportunity only becomes available for a short period of time such as 10-30 seconds (e.g. a free throw is awarded to a player in a basketball game who proceeds to shoot in within 30 seconds and the bet opportunity is on whether the player will score or miss). The available request-response window is too narrow to be able to seamlessly propagate the new betting opportunity to tens or hundreds of millions of users who will need to (A) become aware of the betting opportunity, (B) navigate their way to the betting client, (C) update the list of available bets, (D) analyze the bet details and (E) place and confirm their bet. Such a scenario will only be possible if the user is actively engaged in real time with the betting interface, has a seamless method to receive a new betting enquiry in real time and be able to accurately place a bet in a short amount of time.

Accordingly, there lies a tremendous opportunity for a system that can enable such outcomes for a large number of fans in real-time. The invention proves that such an outcome can be achieved if a betting functionality layer is underpinned by an interactive engagement layer which enables fans to actively spend time in the interface while awaiting the next betting opportunity. The next short term, real time betting enquiry can then instantly present itself when it is available to a user already interacting with the interface in which it is presented. With the proliferation and legalization of sports betting in the United States, this opportunity and its value only grows further.

The present system is based on additional inventions in the areas of user experience design and information architecture structures. They create a system that for the first time allows for a mass delivery of ephemeral, real time betting opportunities to a plurality of fans based on its ability to generate and sustain active engagement from end-users on the basis of social interactivity underpinning the betting portion of the experience. This is accomplished due to the unique design and structure of such mechanisms and their delivery within the collective user experience of the invention.

### SUMMARY OF THE INVENTION

Thus, the general purpose of the invention is to deliver an otherwise impossible real-time betting experience on a mobile phone or web browser to fans that are experiencing a live entertainment event.

Additional understanding of the example digital fan entertainment systems and methods can be obtained by review of the detailed description, below, and the appended drawings.

### BRIEF DESCRIPTION OF THE DRAWINGS

FIG. 1 is a schematic illustration of an example server architecture required to provide real time betting inquiries and social interactivity during live events for a plurality of concurrent client nodes

FIG. 2 is an illustration of a flow diagram for providing real time betting inquiries and social interactivity

FIGS. 3A-B are example graphical user interface (GUI) displays of a device offering a combined real time betting and social interactivity experiences

FIGS. 3C-H are example graphical user interface (GUI) displays of a device at various points of the performance of a real time betting input and graphical mechanism operation according to some embodiments of the invention

FIG. 4. is an example computing system architecture underpinning a cloud service

### DETAILED DESCRIPTION

The following detailed description and the appended drawings describe and illustrate various example embodiments of digital fan entertainment systems and methods. The description and illustration of these examples are provided to enable one skilled in the art to make and use a digital fan entertainment system and to practice a digital fan entertainment method. The examples are not intended to limit the scope of the claims in any manner. While the methods described herein are shown and described as a series of acts, it is to be understood and appreciated that the methods are not limited by the order of acts as some acts may, in accordance with these methods, occur in the order shown and described, in different orders, and/or concurrently with other acts described herein.

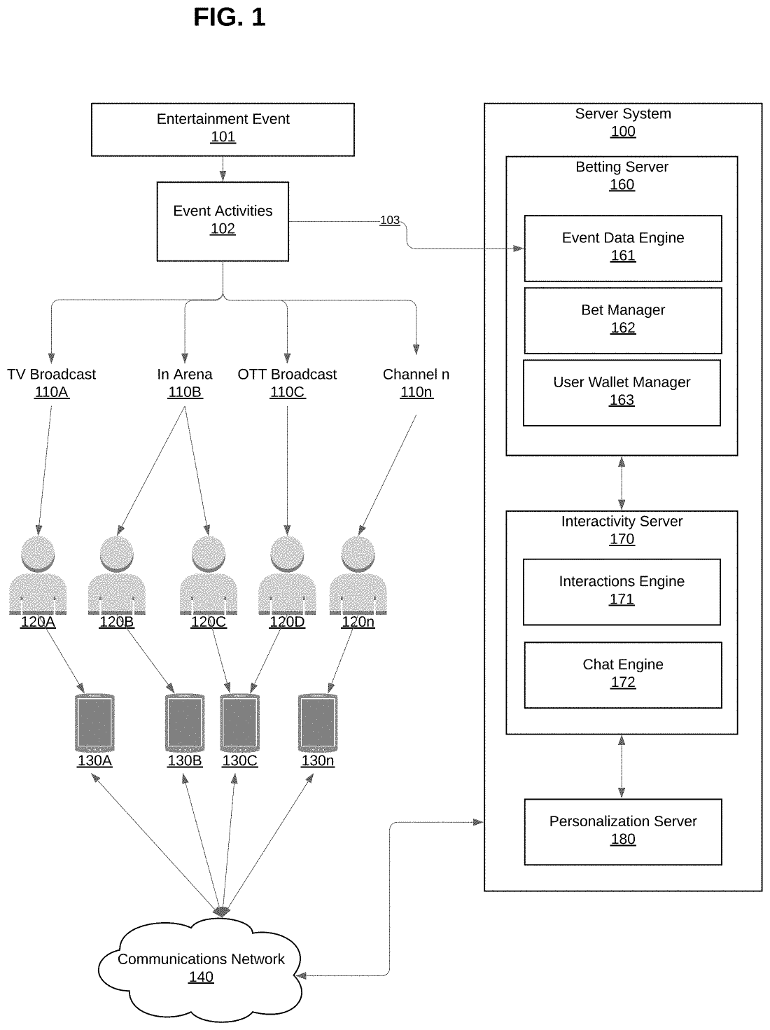

FIG. 1 illustrates a schematic representation of an example digital fan entertainment method. The method is illustrated as a collection of blocks in a logical flow graph, which represents a sequence of operations that can be implemented in hardware, software, or a combination of hardware and software. In the context of software, the blocks can represent computer-executable instructions that, when executed by one or more processors, perform the recited operations. Generally, computer-executable instructions include routines, programs, objects, components, data structures, modules, and the like that perform particular functions or implement particular abstract data types. As indicated above, the order in which the operations are described is not intended to be construed as a limitation, and any number of the described blocks can be combined in any order and/or in parallel to implement a digital fan entertainment method.

The applicant is disclosing systems and methods that provide real time betting opportunities on as-they-happen moments of an entertainment event. In an example illustrated in FIG. 1, a number of fans are watching a sporting match on a linear TV broadcast. Some fans are physically present at the sporting arena where the event is taking place and some are using an Over-The-Top (OTT) form of content delivery to watch the event. Each fan is leveraging a separate version of a system client that uniquely tailors their user experience. In an example scenario such a client may cater to a fan-base of one or both of the teams participating in the sporting, customers of the TV broadcast network showing the event or another standalone client. The fans are looking to amplify their entertainment value and the system facilitates such amplification by creating a gamification and betting environment with a social engagement component tailored to the fan which in turn keeps the fan continuously connected and interacting with the system.

In an example scenario a server system is set up to deliver betting and social functionality to one or more end-users via a client system executing on a mobile or computer client device. End-users leverage a communication network to connect to the server system in order to engage in the betting and social experiences it provides. The system connected to an external event data engine via an application programming interface (API) receives real time or near real time statistics about activities taking place at sporting events and based on predefined programmable logic establishes betting opportunities for such activities. It then communicates those betting opportunities to connected end user client systems for real time input of bets.

Client systems are programmed to receive server system information and send end-user inputs related to either betting or interactivity experiences. The inputs may be related to a specific betting opportunity, an action of the end user or an action of another end user. When interacting with the system an end user may receive a real time, ephemeral betting opportunity based on a newly occurred activity in a sporting event and can immediately render a decision and input in order to make a bet on such an opportunity within a limited time constraint. The client system sends the input to the server system for processing and continues to display and serve interactivity data to the user in the meantime. Interactivity components include a chat system, a message interaction system such as message likes and an emoji cheer component used to express a specific theme or emotion. By interacting with these elements users create a dynamic environment which continues to engage them and keep their client system connected to the server system thus ready to receive new short timed betting opportunities. When a new betting opportunity is established, it is immediately presented to an actively subscribed fan user who can then render a betting decision. Because the user is already connected, they are able to render a decision on a betting opportunity with a very short time window such as 5-10 seconds which normally would be impossible in a traditional betting system.

In addition to end user inputs, the client may also on behalf of the user explicitly or implicitly provide as inputs the following non exhaustive list of variables pertaining to the user; sport or team affiliation, client system version and variant, physical location of the device being used to interact with the client, information about the device. The server system absorbs this information and uses it to coordinate the end user experience based on programmable rules within its personalization engine.

### Example Entertainment & Computing Environment

FIG. 1 is an illustration of a digital computing environment underpinning an entertainment event and providing fans engaged in the entertainment event with a second screen experience depending on the environment the fan is located in or their affiliation (e.g. watching at home on a linear television or a mobile app belonging to a local broadcast provider or fans who are in arena using the apps of the two competing teams which they respectively support). An example computing environment containing a server system 100 connected to client systems as distinct and independent nodes 130A-n operated by content rights holders or related entities and experienced as a distributed second screen experience to end-users 120A-n. Where a letter sequence is present, the letter “n” in an array of similar objects is meant to designate a variant of such an array without implying a final designation such that A, B, C and n are not meant to designate four types of a similar unit or system but that of 3 specific examples and an additional number of other possible examples not limited by a quantity. The entertainment event 101 is meant to designate some external form of live or pre-recorded form of entertainment content such as a sporting game between two teams or a newly broadcast episode of a television show. For each such event, there are event activities 102 which define the narrative of such an event. An example of an activity 102 can be a foul called in a basketball match which will enable the fouled team to have a free throw attempt at the basket to score 1 point. Information about such activities is presently available in the form of application programming interfaces (API's) 103 which communicate structured data about such activities in real time as they take place. The sporting event 101 may be experienced in a variety of physical or digital environments by end users such as a linear television broadcast 110A or a physical presence in the arena in which the event is taking place 110B, in modern times a new form of Over The Top (OTT) broadcasts has emerged whereby the event is delivered to fans via mobile apps or other forms of non-linear digital content delivery 110C-n. Persons operating client systems 130A-n may be referred to as fans, participants or users, sign up or log on to the client system of their choice in order to enhance their experience via the mentioned forms of additional entertainment, i.e. interactivity and real time betting. In the example scenario, client System 130A may be offered by a television broadcaster to their viewers as a way to enhance the broadcast experience. Client system 130B and 130C may be offered respectively by each of the teams participating in the event in order to enable their fan bases to enhance their fan experience. In this way fan 120C consuming the event in the arena is joined by fan 120D who is consuming using an OTT broadcast in using client system 130C provided by the team they support. Each client system on behalf of its users receives input information in the forms of a touch screen action, camera activity or recording, microphone, physical or digital keyboard, mouse or any other input method for their respective available activities such as making a new bet or interacting with a chat message.

The Server System 100 contains a Betting Server 160, Interactivity Server 170 and a Personalization Server 180 and is connected to the clients via a typical Communication Network 140 such as the World Wide Web. Betting Server 160 contains an Event Data Engine 161 programmed to receive structured information related to real time activities happening during an entertainment event and in response to certain activities generates new betting opportunities (e.g. if a penalty is called during a soccer match, generate a 30 second betting opportunity of “Will Team A score the penalty”) . The information used by the Event Data Engine 161 can be received via an Application Programming Interface (API) or another method. The bets are then presented to end-users by a programmable Bet Manager 162 that also records user inputs and when presented with the outcome of the bets calculates winnings and losses based on pre-defined logic available in common betting systems. The bet manager shares the resulting outcome with the User Wallet Manager 163 which is responsible for managing the available betting means of each end user such as a points balance system, fiat currency balance or a digital currency.

An Interactivity Server 170 consisting of an Interactions Engine 171 and Chat Engine 172 are deployed within the Server System 100 in order to continuously engage end-users and keep them connected and subscribed to the system via the communication Network. The Interactions Engine 171 is programmed to record and broadcast interactions between and to end users in their respective client systems. In an example embodiment, an interaction may include an action one end user performs with respect to his own account or with respect to that of another user such as liking a chat message or wagering a large sum on a new betting opportunity. The interaction engine 171 captures that user 120A liked the message of user 120B and sends it to the connected client nodes 130A-n in order to provide the node users with new information and activities that will keep them connected to the system. Another example can be a notice that player 120C just bet all of their funds on the latest betting opportunity. The Chat Engine 172 is programmed to send and receive text chat messages between connected client applications based on existing chat connections between respective clients.

A Personalization Server 180 is deployed within the embodiment to provide and maintain a continuous interactivity experience to end-users that increases the length of time they remain connected to the system. It is programmed to ensure that each end-user is only receiving the appropriate betting opportunities and chat or interaction information that enhance their experience. In an example embodiment, user 120C who is watching the entertainment event in the arena will receive an additional betting opportunity because of the physical location his client node 130C has automatically shared with the Server System. Another personalization function example that can be performed by the Personalization Server 180 can be to filter chat messages from end user 120B in the client system of user 120C because user 120B is interacting with the system via client 130B which is a designated client for opposing team fans. Thus the personalization engine will tailor and customize the interactive experience to appeal to each individual user.

### Example Real Time Betting & Social Interactivity Method

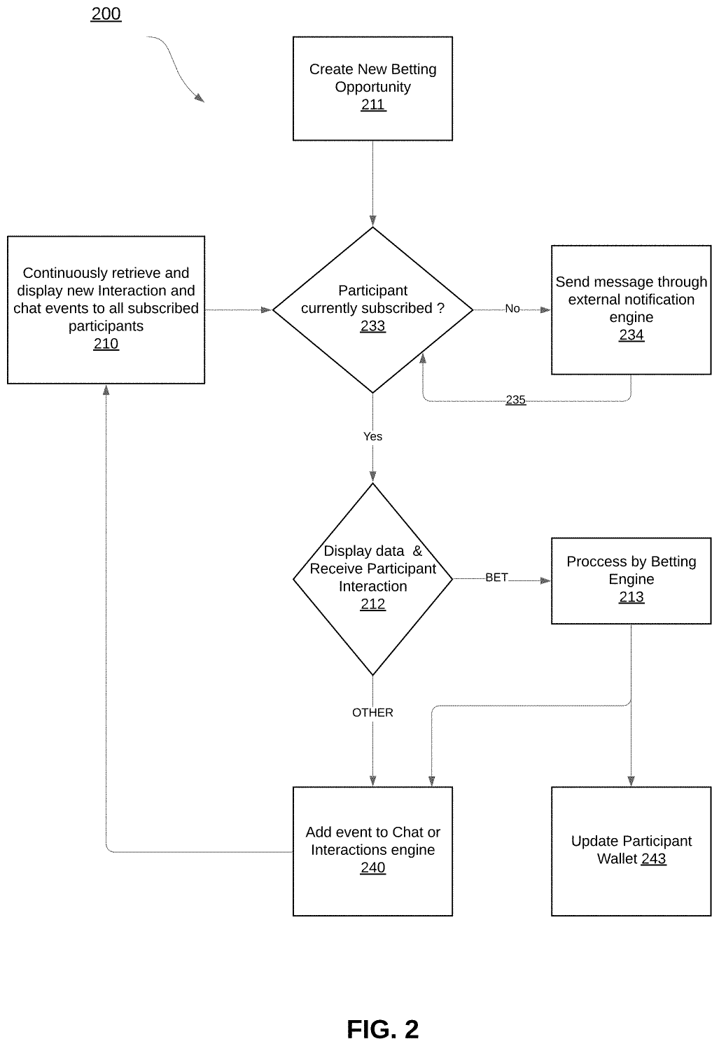

FIG. 2. contains a diagram of method 200 comprising processing steps that provide a real time betting opportunity to a fan consuming an Entertainment Event 101 within an interactive environment for example a short timed, ephemeral betting opportunity of whether a player will successfully complete a free throw in a basketball game within the next 20 seconds. Such a fan 120A watching the event using a television broadcast 110A or a person 120B present in the arena 110B will be initiating and participating in a secondary experience related to real time betting and digital fan interactions. As shown, at block 210 the server system 100 is continuously retrieving and displaying new interaction and chat information on the respective client systems 130A and 130B.

Upon a new activity 102 taking place during event 101, a betting server 160 receives information about the new activity 102 such as a free throw being awarded to a team during a basketball events via an API service 103 and produces a new bet opportunity using a pre-programmed method within a Bet Manager service 162 of whether the fouled team will score the upcoming throw. Such a bet opportunity can only exist for a short duration of time such as 20-40 seconds in which they can be delivered to a fan and rendered a response. Thus the system at block 211 will render the new betting opportunity to those participants presently subscribed to their respective client systems.

Block 233 offers an alternative method of leveraging an external notification engine to notify those participants who may have switched away from the system while betting opportunity 211 was created. Step 211 comprises obtaining data relating to an event. Another step 212 comprises presenting an inquiry to a plurality of fans based on the data (e.g., presentation of a bet). The inquiry relates to a potential outcome of a portion of the event. A first set of fans of the plurality of fans in attendance at the event. A second set of fans of the plurality of fans are not in attendance at the event. Another step 212 comprises obtaining a response to the inquiry from each fan of the plurality of fans (e.g., placing a bet). Another step 213 comprises compiling the response to the inquiry from each fan of the plurality of fans and obtaining data relating to the outcome of the portion of the event. Step 213 comprises comparing the data relating to the outcome of the portion of the event or an activity 102 and the response to the inquiry from each fan of the plurality of fans. Another step 243 comprises determining whether the response to the inquiry from each fan of the plurality of fans is correct and rendering an appropriate calculation and balance update to their participant wallet. Step 213 when processing an input from a user will leverage the updated balance in its function during the next betting opportunity such as to establish the available means a system user has for a new wager.

Step 240 comprises presenting to each fan of the plurality of fans data relating to whether the response to the inquiry is correct it includes presenting to the plurality of fans data relating to whether the response to the inquiry from each fan of the plurality of fans is correct. The method by which such data could be presented can include a chat engine method whereby fans engaged in a chat session with a certain fan who made a correct prediction will receive an automated message mentioning this occurrence. For example, if a fan 120B bet all of their means that the team will not score the free throw, a message may appear to this effect for fans 120C and 120D inside a client system 130C belonging to the team failing to score the throw. Such an experience adds to the interactive and social nature of competitive sports and general competition in the gamification process of entertainment events and will aid in maximizing the number of fans participating in Step 210 and thus being subscribed to the system at Step 233 and ready to receive new Betting Opportunities from Step 211.

As more users become connected to the system, more information is generated by the participants within the scope of the interactivity server, this includes more chat conversations, interactions with user messages, notifications about user bet activity to others and more, this function has a snowball effect as it generates more interactivity opportunities for others such that if team A fans begin to discuss how much better their team is historically than Team B, then Team B fans will decide to rebuttal with the fact that in the present season Team B is outperforming team A significantly. Such social, tribal and competitive activities of the social nature will drive connected participants into Step 233 allowing the system to bypass the present day approach of betting systems that use tactics similar to those described in 234 for engagement via external notifications and reminders.

In the event where the degree of activity in Step 210 becomes too great such that it diminishes rather than enhances the entertainment value of a fan, for example if there are too many messages being broadcast to its client system such that the user cannot read them or respond to them in a manner that reflects a regular interaction activity of a typical user, in such instances the personalization server 180 may adjust the variables of its pre-defined logic such as limiting the number of connections each user has to a humanly manageable number of conversational peers, for example 100 fans maximum.

Certain methods or process blocks may have been omitted in some of the implementations or examples. The methods and processes are not limited to any particular sequence and can be executed in other sequences when applicable such as performing steps in parallel or another form of variance.

Another optional step that can be included in method 200 comprises presenting an interactive social experience simultaneously with presenting to each fan of the plurality of fans, or presenting an interactive social experience simultaneously with presenting to the plurality of fans, data relating to whether the response to the inquiry is correct. Alternatively, an interactive social experience can be provided prior to, during, or subsequent to the event. Optionally, an interactive social experience can be provided during the period of time between presenting the inquiry and presenting a second inquiry to the plurality of fans based on the data.

Another optional step that can be included in method 200 comprises requiring the submission of a form of payment from each fan of the plurality of fans when obtaining the response to the inquiry from each fan of the plurality of fans where a form of betting units can include monetary forms of payment or other forms of electronic currency. The form of payment can be provided by a third party (e.g., owner of a team involved in the event, entity associated with the event).

Another optional step that can be included in method 200 comprises rewarding a fan of the plurality of fans if the response to the inquiry is correct where a reward can include any suitable reward such as monetary rewards, electronic currency, sponsored prizes, and/or physical objects (e.g., apparel, toys).

Another optional step that can be included in method 200 comprises performing the method for a first fan of the plurality of fans using a first application provided by a first operator and for a second fan of the plurality of fans using a second application provided by a second operator that is different than the first operator. Alternatively, or in combination with the previous optional step, the method can be performed for a third fan of the plurality of fans using a first application provided by a first operator and for a fourth fan of the plurality of fans using the first application provided by the first operator.

Other optional steps that can be included in method 200 comprise associating each fan of the plurality of fans with a score based on whether the response to the inquiry from each fan of the plurality of fans is correct and presenting to each fan of the plurality of fans data relating to the score through a leaderboard being presented to a fan simultaneously with data relating to the score. The leaderboard gamifies a fan's response to the presented inquiries with status identifiers and rewards. Other optional steps that can be included in method 200 comprise associating each fan of the plurality of fans with a support score based on support (e.g., Cheer Emojis 344) provided to a contestant in the event and presented to each fan of the plurality of fans data relating to the support score.

Optionally, each step, alternative step, and/or optional step can be repeated prior to the event, throughout the event, and/or subsequent to the event. Optionally, each step, alternative step, and/or optional step can be automated.

The methods described herein are sports agnostics and can be performed relative to any type of event, such as a sporting event, video game event, entertainment event, live-stream event, concerts, rallies, tournaments, and any other event considered suitable for a particular embodiment. The methods described herein can be integrated into existing distribution channels (e.g., online, mobile apps) to provide engagement opportunities via sponsorship, support (e.g., cheers), e-commerce. The methods described herein can include a backend dashboard allowing for social and marketing teams to develop and broadcast inquiries, awards, points, and increase community building through chat forum moderation. Furthermore, the methods described herein can utilize machine learning to aggregate user behavior data over time and incorporate event statistics and external data to increase engagement with fans.

Each of the steps, alternative steps, and/or optional steps described herein may be accomplished real-time such that data can be provided to a fan that is up to date and relevant to the current status of the event. Accomplishing each of the steps, alternative steps, and/or optional steps in real-time are limitations that cannot practically be performed in the human mind. For example, the human mind is unable to obtain data relating to an event; present an inquiry to a plurality of fans based on the data (e.g., presentation of a bet), the inquiry relating to a potential outcome of a portion of the event; obtain a response to the inquiry from each fan of the plurality of fans (e.g., placing a bet); compile the response to the inquiry from each fan of the plurality of fans; obtain data relating to the outcome of the portion of the event; compare the data relating to the outcome of the portion of the event and the response to the inquiry from each fan of the plurality of fans; determine whether the response to the inquiry from each fan of the plurality of fans is correct; present to each fan of the plurality of fans data relating to whether the response to the inquiry is correct; and/or present to the plurality of fans data relating to whether the response to the inquiry from each fan of the plurality of fans is correct. In addition, the human mind is unable to complete such steps when a first set of fans of the plurality of fans are in attendance at the event and a second set of fans of the plurality of fans are not in attendance at the event (e.g., are remote to the event).

### User Interface Corresponding to Active Events, States or Methods

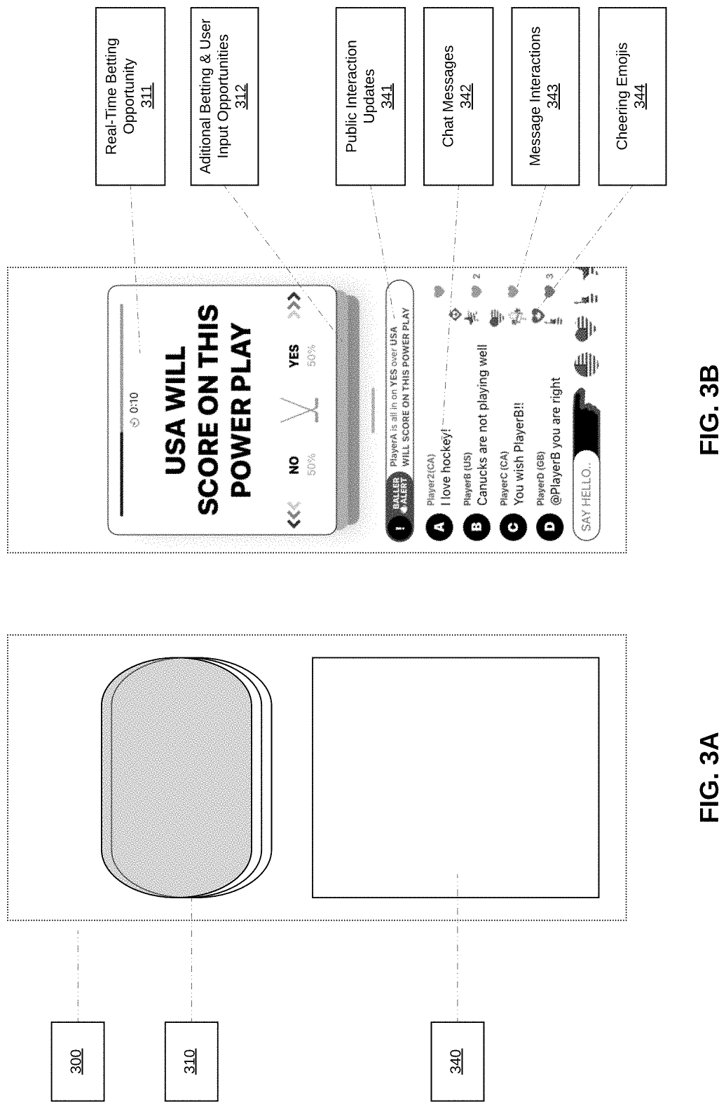

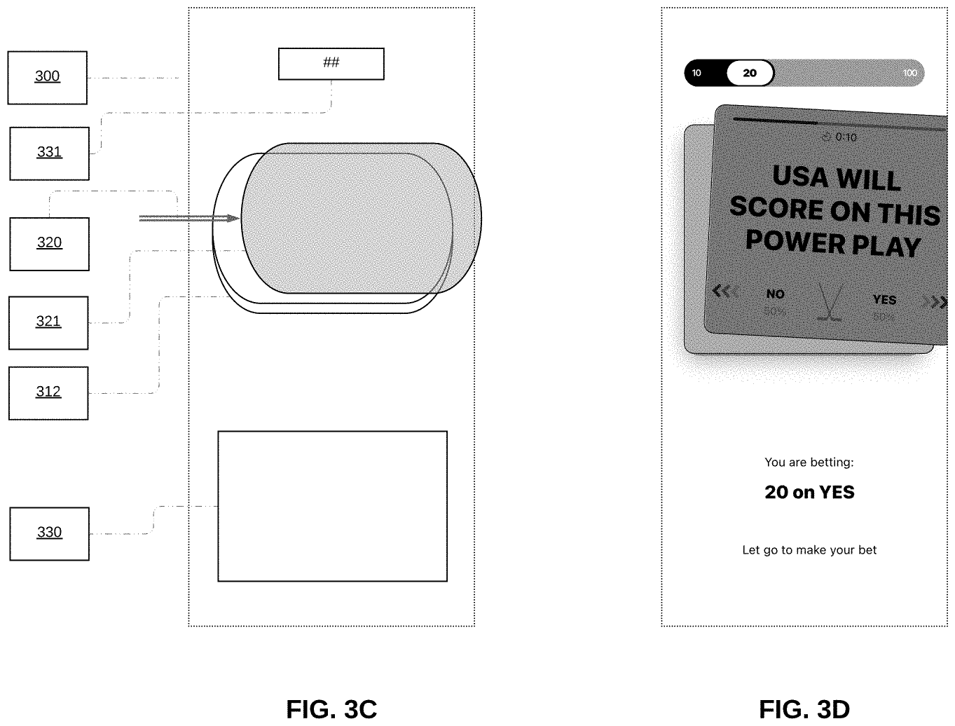

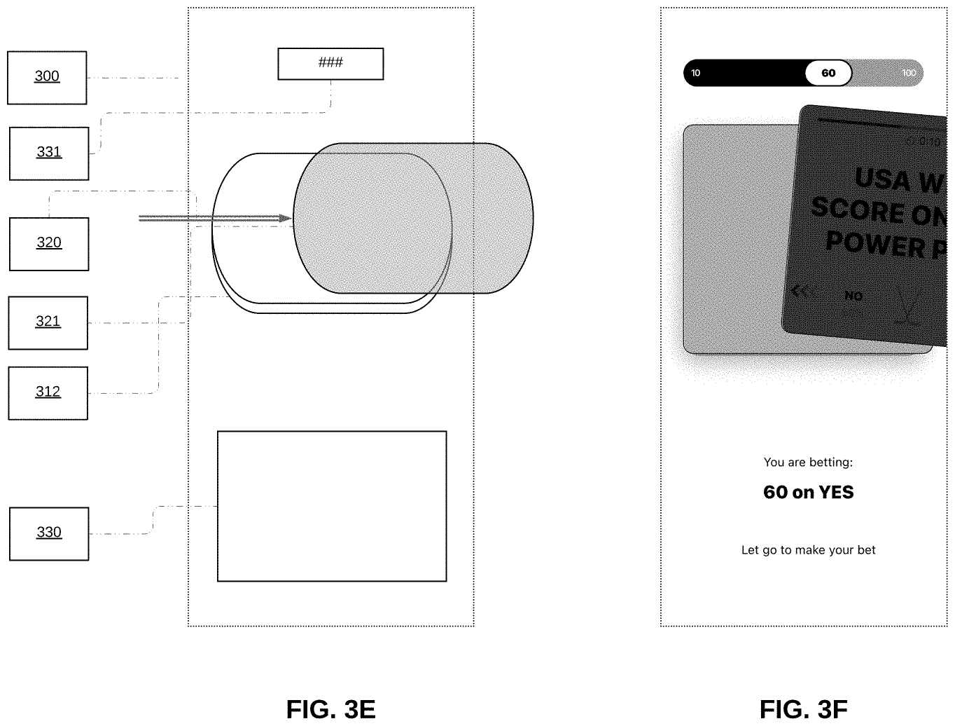

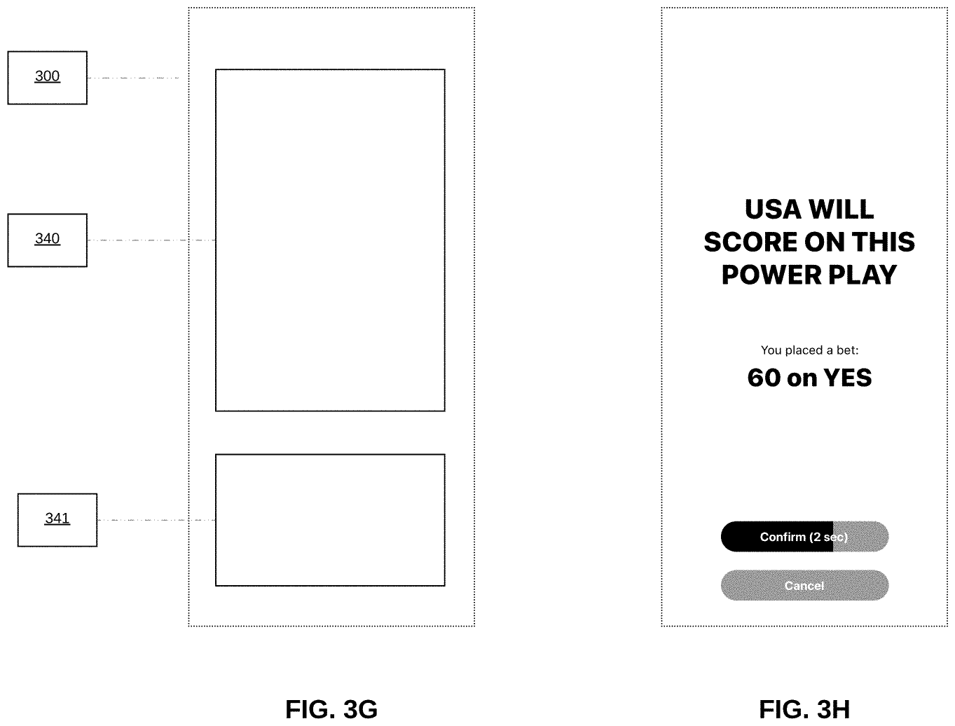

FIG. 3A Illustrates an example of a graphical user interface system (GUI) of a device 300 with a touchscreen or another input method that can be displayed to a plurality of fans on client devices comprising section 310 intended for betting and data inputs and section 340 intended for interactive elements.

FIG. 3B is a more detailed example of a GUI on a client device that can be displayed to a plurality of fans at steps 210 and 211 to present interaction information and a real time betting inquiry or opportunity 311 based on the data available in Step 211. In the illustrated embodiment, the inquiry is a real-time binary response inquiry (e.g., presentation of a bet) presented during an example hockey game event 101 and the potential outcome of a specific activity 102 (e.g. Team USA is awarded a Power Play) of the event comprises a potential outcome relating to the event (e.g. Team USA will score during the power play) the response to which the user has only 10 seconds to provide as the power play will begin momentarily after the whistle. Alternatively, the inquiry can be presented prior to and/or subsequent to the event and/or can relate to any suitable information (e.g., information not related to the event or an outcome of a portion of the event). In the illustrated embodiment, step 212 is accomplished prior to the portion of the activity 102 occurring. As shown in FIGS. 3 and 3A, the inquiry is presented on a gamification or betting portion 310 of two portions of the user interface 300. Any suitable inquiry or betting opportunity 311 can be presented to a fan and selection of a suitable inquiry can be based on various considerations, including the desired information intended to be obtained from the fan. For example, an inquiry can relate to the event, to the fan (e.g., identifying information, gender, age, address, etc.), to a sponsor, to a marketing partner, and/or any other information. Presenting a fan with real-time inquiries during an event provides a mechanism for obtaining rich data that can be captured for each fan, creating custom segments/analytics for contestants of the event and/or sponsors including enhancing the capabilities of the Personalization Server component 180 of the Server System 100. Additional betting and input opportunities 312 can be displayed in the form of an array of stacked cards or other illustration mechanisms that allows for multiple enquiries to be presented to the end user either sequentially or at the same time.

Portion 340 of the GUI presented on device 300 is intended to offer a plurality of fans a continuous interactive experience in order to be able to present short term ephemeral betting opportunities 311 and 312 when they arise. In an example embodiment in FIG. 3B the GUI portion comprises a Public Interaction Update element 341 deployed to notify a plurality of fans of activities that Personalization Engine 180 may deem relevant or interesting to then (e.g. a contact of the just bet all of their means on the current betting opportunity 311). It also comprises a standard chat function sending text messages between a plurality of fans based on a pre established set of connections driven in part by user activity, data and programmable logic in the Personalization Server 180. Each message contains a Message Interaction component 343 in the form of a like such that the users receiving the message can award it a like if they find it entertaining and valuable. Such data inputs comprise a portion of the information the programmable logic in 180 uses to establish which users to keep connected to each other. Cheering Emojis 344. Emojis are small graphical elements meant to signify a particular sentiment, person, organization or other element of interest to a fan as a virtual analogy of a physical cheer experience in a stadium (e.g. “Defence!”). Cheer Emojis 344 are deployed contextually within each client system 130A-n such that they are themed to the organization presenting the experience to the fan (e.g. Team USA may have a variety of national visuals while as shown in FIG. 3B). These visual elements when tapped at the bottom of the screen will fly across the element 340. The more fans tapping these elements the more of them will be visible on the screen in element 340 as a visual manifestation of a physical cheer in a stadium environment or a concert hall. It is understood that each client 130A-n may have their own version of contextual Cheering Emojis 344 such that when tapped inside their respective clients, they will appear in any relevant client (e.g. Team USA client 130B has a unique subset of Cheer Emojis 344 while Team Canada client 130C will have a second unique subset). When these unique emojis are tapped on they will collectively appear flying across the screen of both clients creating a visual representation of an auditory or sensory physical experience during an entertainment event such as a hockey match between both teams. Optionally, a fan can be provided with a number of cheers prior to, or at the beginning of, each event. As the event progresses, the fan can use the cheers to support their contestant and, optionally, purchase more cheers or get more cheers as they receive more likes on their messages.

The size and other attributes of portions 310, 340 or their respective elements 311, 312, 341, 342, 343 and 344 may be adjusted in response to the presently available data in steps 210 and 211 such that if no current betting opportunities are present, the interactivity portion 340 and its elements may grow in size or shift their position to maximize device 300 screen utilization until a new betting opportunity is presented in a new Step 211.

FIG. 3C illustrates an example user interface receiving a response to the inquiry 311 being obtained from a fan of the plurality of fans to accomplish step 212. In the illustrated embodiment, the response is provided by a swiping motion 320 across a touch screen user interface on device 300 of a portion of a user interface element 321 symbolizing element 311 in motion in a first direction or a second direction. Optionally, obtaining the response to the inquiry from each fan of the plurality of fans can be accomplished concurrently. Element 330 is meant to assist the user in by confirming the amount the user wishes to bet and the outcome while element 331 quantifies the amount being bet on the outcome symbolizing the direction in which he is dragging the card. FIG. 3D is a more detailed example of a GUI of the methods described in FIG. 3C.

FIG. 3E illustrates an example user interface receiving a greater response than that illustrated in FIG. 3C such that the element 321 is dragged further by input 320. When the force dragging the interface is removed such that the finger dragging it across the touchscreen display is lifted, the input is processed and sent to step 212. FIG. 3F is a more detailed example of a GUI of the methods described in FIG. 3E.

FIG. 3G illustrates an example user interface in the final stage of a user performing step 212 consisting of an information element 340 reiterating to the user the details of the input and element 341 which serves as the final input from a user before the input is recorded and sent for processing in step 213. Elements 340 and 341 appear for a short number of seconds (e.g. 5 seconds) whereby element 341 allows the user to confirm their input or cancel to nullify it. FIG. 3G is a more detailed example of a GUI of the methods described in FIG. 3H.

In some embodiments, the arrows on element 311 may be animated to assist the user in the performance of rendering an input. The sub elements displaying bet options may also be clickable such as to allow users to tap the option repeatedly to increase the bet size they wish to render. Once the user stops tapping for a prolonged period of time (e.g. 2 seconds) the GUI illustrated in FIGS. 3G and 3H will allow the user to confirm or cancel their input.

### Example Processing & Delivery Architecture

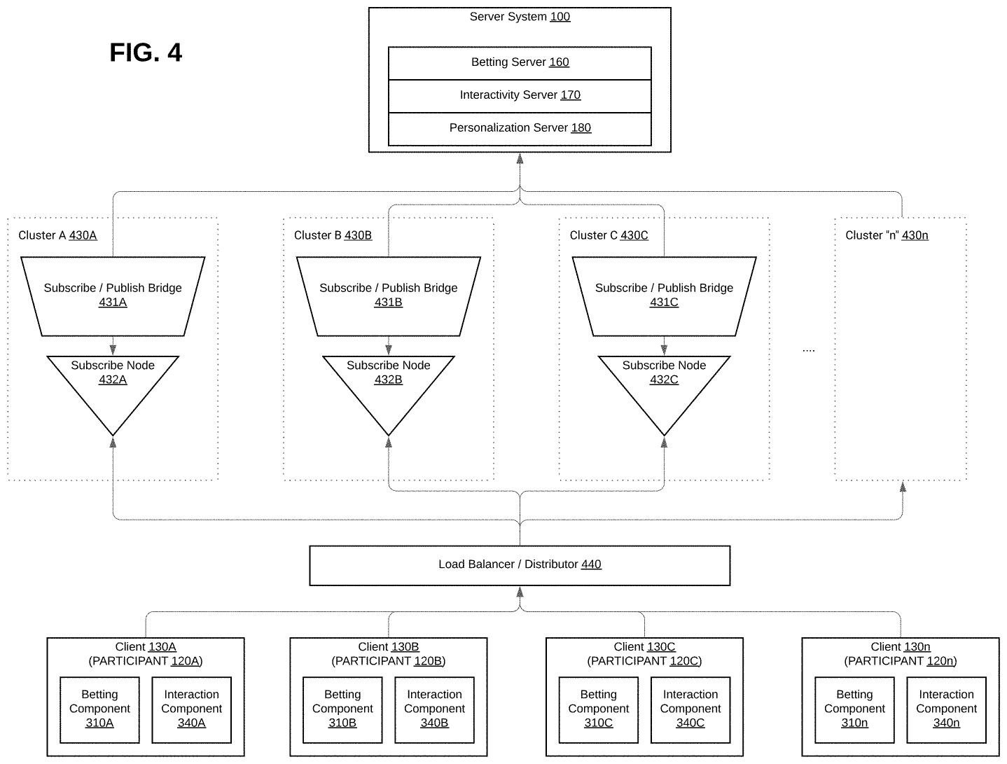

The methods described in connection with FIG. 2 may be executed in a variety of given architectures adapted to connect client nodes through a suitable network such as the world wide web to a server architecture and cloud based web services. FIG. 4 depicts an example cloud services architecture environment that connects client nodes to a data center containing the Server System 100 in a way that supports the basic premise of the invention. Since today's betting systems power more traditional bet structures that allow betting opportunities to be available for longer periods of time tied to outcomes far into the future (e.g. will Team A win the game next week) they can be delivered to fans over extended periods without high concurrency (e.g. each fan will access the system over the course of the week at their own discretion to place a bet). The methods described in the invention which enable the real-time delivery allow for a new format of betting experiences that live over a short period of time (live betting), to a plurality of fans which require high concurrency (e.g. all fans consuming the event will need to instantly know about a 10 second betting opportunity when Canada fouls the USA in a hockey match). FIG. 4 is schematically illustrates how such high concurrency may be sustained within one or many data center environments hosting the Server System 100 that are being accessed by fans from client devices 130A-n via a communication network. The computing resources described in FIG. 4 are not meant to limit the totality of the resources required to deliver the methods and benefits described but rather highlight an example architecture that can sustain high real time concurrency during an entertainment event. It accomplishes this by deploying clusters of server nodes 430A-n containing a subscribe continuously subscribes to the main Server system processing event activities data 102 and initiating Step 211. When a new bet is generated in Step 211 a Subscribe/Publish Bridge 431 receives the relevant information through its subscription connection to 100/162 and publishes it to a subscribe node 432. This process can be replicated indefinitely in a linear fashion such that a plurality of clusters can connect to the master server system. Each client node 130 initiates a connection to the system via a Load Balancer 440 that maintains existing connections and directs traffic to available clusters, upon executing a connection the client 130 becomes connected to the Subscribe Node 432. Each node 432 given modern day server architecture can sustain thousands to millions of connections and each data canter can contain thousands to millions of clusters 430 for connection to a master system 100. Thus the available pool of sustainable participants becomes one that resembles the effects of a traditional radio station whereby one station is broadcasting information to an infinite number of listeners (subscribers). The network topology in FIG. 4 and FIG. 1 have been simplified as generally more commonplace networking devices and architecture elements may be utilized to interconnect various client nodes and internal systems disclosed. Such topologies should be apparent to those skilled in the relevant art of. Portions or copies of the system may be placed or located in different physical locations to reduce proximity and latency for participants in a specific physical location.

The steps, alternative steps, and optional steps described herein can be completed using any suitable technique or method and selection of a suitable technique or method to complete the steps, alternative steps, and optional steps described herein can be based on various considerations, including the type of digital fan entertainment intended to be provided to a fan. Example techniques and methods considered suitable to complete the steps, alternative steps, and/or optional steps described herein include using a phone service, using a computer, using one or more electronic devices, using a client-server computer system, using a client-server computer system in which at least one of the client or server is connected to a network (e.g., the Internet), using a web application, using a mobile application, using an application provided by an entity associated with the event, using a computer-readable medium, an application provided by a third party, an Application Program Interface (API), a software development kit (SDK), browser extension, combinations of the techniques and methods described herein, and/or any other technique or method considered suitable for a particular embodiment. As described herein, embodiments of the digital fan entertainment methods can be implemented in suitable computer-executable instructions that may reside on a computer readable medium, hardware circuitry, or any combination of suitable components. For example, the computer-executable instructions may be stored as software code components or modules on one or more computer readable mediums. The computer-executable instructions may include lines of any suitable code, such as Python, C++, Java, Objective C, SWIFT, HTML, or any other programming or scripting code.

The steps, alternative steps, and/or optional steps described herein may be implemented on one computer or shared, distributed, among two or more computers. Communication between computers implementing the steps, alternative steps, and/or optional steps described herein can be accomplished using any electronic, optical, radio frequency signal, or other suitable techniques or methods of communication. A computer, such as those described herein, can include a central processing unit (“CPU”), at least one read-only memory (“ROM”), at least one random access memory (“RAM”), at least one hard drive (“HD”), a server, and/or one or more input/output (“I/O”) device(s), among other devices and/or components. The I/O devices can include a keyboard, monitor, printer, electronic pointing device (such as a mouse, trackball, stylist, etc.), or any other suitable I/O device. In various embodiments, the computer has access to at least one database or external source that may include a database over a network. Each of ROM, RAM, and HD are computer-readable mediums for storing computer instructions executable by the CPU. While various types of computer-readable mediums have been described, any suitable computer-readable medium can be used to store data and/or instructions relating to completing the steps, alternative steps, and optional steps described herein. Examples of computer-readable mediums considered suitable to store data and/or instructions relating to completing the steps, alternative steps, and optional steps described herein include ROM, RAM, HD, a database, a data cartridge, a data backup magnetic tape, a floppy diskette, a flash memory drive, an optical data storage drive, a CD-ROM, non-volatile memories, volatile memories, DASD arrays, magnetic tapes, floppy diskettes, optical storage devices, and any other type of computer-readable medium that can be read by a processor.

In an example, at least one computer readable medium or memory can be programmed according to one or more of the methods, steps, optional steps, and/or alternative steps described herein and/or can contain data structures, tables, records, content, or other data described herein. Examples of computer readable media include non-transitory media, non-transitory computer-readable storage media, compact discs, hard disks, floppy disks, tape, magneto-optical disks, PROMs (EPROM, EEPROM, Flash EPROM), DRAM, SRAM, SDRAM, any magnetic mediums, compact disks (e.g., CD-ROM), any optical mediums, punch cards, paper tapes, physical mediums with patterns of holes, carrier waves, any medium from which a computer can read, and/or any other computer readable media considered suitable for a particular embodiment. Stored on any one or on a combination of computer readable media, the one or more methods, steps, optional steps, and/or alternative steps described herein can include software for controlling the computer system, for driving a device or devices (e.g., one or more processors) for implementing the one or more methods, steps, optional steps, and/or alternative steps described herein, and/or for enabling a fan device and/or a system server to interact with a fan. Such software may include, but is not limited to, device drivers, operating systems, development tools, application programs, and applications software. Such computer readable media can further include the computer program product of the one or more methods, steps, optional steps, and/or alternative steps described herein for performing a portion (e.g., if processing is distributed), or the entirety, of the processing performed in implementing the one or more methods, steps, optional steps, and/or alternative steps described herein.

Any method, step, optional step, alternative step, logic, and/or application described herein, including, but not limited to, method 200 can comprise software or code that can be embodied in a non-transitory computer-readable medium, or one or more non-transitory computer-readable storage media, for use by, or in connection with, an instruction execution system such as, for example, a processor (e.g., processor) in a computer system (e.g., fan device, system server) or other system. In this sense, the method, step, optional step, alternative step, logic, or application, may comprise, for example, statement(s) including instructions and declarations that can be fetched from the computer-readable medium and executed by the instruction execution system.

While various steps, alternative steps, and optional steps have been described above with respect to method 200, these steps, alternative steps, and optional steps can be included in, accomplished concurrently with, and/or accomplished in the alternative to, the other methods, steps, alternative steps, and/or optional steps described herein.

The schematic illustrations of FIG. 4 are an example digital fan entertainment system where the illustrated embodiment is capable of handling a plurality (e.g., millions) of concurrent users and a plurality (e.g., hundreds of millions) of inquiry responses per second. The system can consolidate traffic from multiple contestants of an event, leagues, etc. into an overlapping fan experience, as described herein (e.g., opposing team fans compete from respective team applications as well as fans using an application of their local sports broadcast network).

Those with ordinary skill in the art will appreciate that various modifications and alternatives for the described and illustrated examples can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor simply to describe and illustrate examples of the invention and are not intended to limit the scope of the invention or its protection, which is to be given the full breadth of the appended claims and any and all equivalents thereof.

What is claimed is:

1. A method for providing management of real time betting inquiries involving a plurality of fans, comprising:
serving social interaction content and functions on second screen client devices of a plurality of fans by an interactivity server;
obtaining, by a betting server data relating to an activity portion of an entertainment event from a plurality of 3rd party sources;
presenting, a real-time, short term inquiry to a plurality of fans based on the data, wherein the inquiry is relating to a potential outcome of an activity portion of the event for which new data was obtained,
receiving concurrently a real time response to the inquiry from each fan of the plurality of fans;
determining whether the response to the inquiry from each fan of the plurality of fans is correct based on further data relating to the outcome of the portion of the event and the response to the inquiry from each fan of the plurality of fans;
presenting to the plurality of fans data relating to whether the response to the inquiry from each fan of the plurality of fans is correct; and
serving, additional social interaction content and functions while awaiting new activity data to present additional inquiry opportunities.

2. The method of claim 1, wherein the potential outcome of the portion of the event comprises a potential single moment relating to the event or a potential statistic relating to the event.

3. The method of claim 1, further comprising receiving and delivering chat messages between connected fans while they are connected to an interaction server; and
receiving and delivering message interaction activities between connected fans while they are connected to an interaction server; and
receiving and delivering information updates about inquiry responses and information data received about event activities to connected fans while they are connected to an interaction server; and
receiving and delivering a visual version of a group cheer through visual cheer emoji stickers between connected fans while they are connected to an interaction server

4. The method of claim 1, wherein obtaining the response to the inquiry from each fan of the plurality of fans requires submission of a form of payment from each fan of the plurality of fans and rewarding a fan of the plurality of fans with a greater payment if the response to the inquiry is correct.

5. The method of claim 1, wherein the method is performed for a first fan of the plurality of fans using a mobile application provided by a first operator; and
wherein the method is performed for a second fan of the plurality of fans using a second mobile application provided by a second operator that is different than the first operator.

6. The method of claim 1, wherein presenting the inquiry to the plurality of fans based on the data is presented on a first portion of a user interface; and
wherein said fan provides an accelerated response by swiping the first portion of the user interface in a first direction or a second direction; and
wherein the fan confirms his response in a final interface outlining the details of the response

7. The method of claim 1, wherein connecting fans to one another comprises; using data about the organization facilitating the interface used by the fan, and
using information shared by the device of the fan or provided by the fan; and
executing predefined rules defining optimal conditions for a social experience based at least on the number of connections each fan should have and available interaction rules pertaining to the organization providing the fan experience

8. A system for providing management of real time betting inquiries involving a plurality of fans, comprising:
a plurality of computing nodes forming a computing node network; and
with non-transitory computer-readable storage media containing instructions that can cause the computing node to perform operations comprising: obtain data relating to the event, present a real time betting inquiry to the plurality of fans based on the data, obtain the response to the inquiry from each fan of the plurality of fans, compile the response to the inquiry from each fan of the plurality of fans, obtain data relating to the outcome of the portion of the event, compare the data relating to the outcome of the portion of the event and the response to the inquiry from each fan of the plurality of fans, determine whether the response to the inquiry from each fan of the plurality of fans is correct, present to each fan of the plurality of fans data relating to whether the response to the inquiry is correct, and present to the plurality of fans data relating to whether the response to the inquiry from each fan of the plurality of fans is correct.: and
deliver and receive social interactions and information updates for the plurality of connected fans subscribed over a continuous information channel.

9. The system of claim 8, further comprising:
distributing a plurality of fan client interface systems to a plurality of fan client devices located in various geographic locations by a plurality of operators providing the experience;

10. The system of claim 8, further comprising:
delivering of the enquiry and obtaining the response to the inquiry from each fan of the plurality of fans is accomplished concurrently and in real time using a continuous subscription to an information channel of the server system

11. The system of claim 8, further comprising:
establishing a network subscription from a client interface system to a continuous information channel is based upon a delivery of continuous social interaction functions and data to the client interface

12. The system of claim 8, further comprising delivering social interaction content and function by:
receiving and delivering chat messages between connected fans while they are connected to an interaction server; and
receiving and delivering message interaction activities between connected fans while they are connected to an interaction server; and
receiving and delivering information updates about inquiry responses and information data received about event activities to connected fans while they are connected to an interaction server; and
receiving and delivering a visual version of a group cheer through visual cheer emoji stickers between connected fans while they are connected to an interaction server

13. A non-transitory memory having stores programs to cause a computing device to:
obtain data relating to an entertainment event, present a real time betting inquiry to a plurality of fans based on the data, obtain the response to the inquiry from each fan of the plurality of fans, compile the response to the inquiry from each fan of the plurality of fans, obtain data relating to the outcome of the portion of the event, compare the data relating to the outcome of the portion of the event and the response to the inquiry from each fan of the plurality of fans, determine whether the response to the inquiry from each fan of the plurality of fans is correct, present to each fan of the plurality of fans data relating to whether the response to the inquiry is correct, and present to the plurality of fans data relating to whether the response to the inquiry from each fan of the plurality of fans is correct.: and
deliver and receive social interactions and information updates for the plurality of connected fans subscribed over a continuous information channel.

14. The non-transitory memory of claim 13, the programs being further programmed to:
receive and deliver chat messages between connected fans while they are connected to an interaction server; and
receive and deliver message interaction activities between connected fans while they are connected to an interaction server; and
receive and deliver information updates about inquiry responses and information data received about event activities to connected fans while they are connected to an interaction server; and
receive and deliver a visual version of a group cheer through visual cheer emoji stickers between connected fans while they are connected to an interaction server

14. The non-transitory memory of claim 13, the programs being further programmed to:
use data about the organization facilitating the interface used by the fan, and
use information shared by the device of the fan or provided by the fan; to
execute predefined rules defining optimal conditions for a social experience based at least on the number of connections each fan should have and available interaction rules pertaining to the organization providing the fan experience
